(19) United States
(12) Patent Application Publication
(10) Pub. No.: US 2026/0121344 A1
(43) Pub. Date: Apr. 30, 2026

(54) HIGH SPEED, RUGGEDIZED COMPACT CABLE CONNECTOR

(71) Applicant: Amphenol East Asia Electronic Technology (Shenzhen) Co., Ltd., Shenzhen (CN)

(72) Inventors: Koen Maddens, Hofstade (BE); Danren He, Shenzhen (CN); JianQiang Shen, Shenzhen (CN)

(73) Assignee: Amphenol East Asia Electronic Technology (Shenzhen) Co., Ltd., Shenzhen (CN)

(21) Appl. No.: 19/119,391

(22) PCT Filed: Oct. 10, 2022
(86) PCT No.: PCT/CN2022/124348

§ 371 Date: Apr. 8, 2025

(51) Int. Cl. H01R 13/627; H01R 11/28; H01R 12/72; H01R 12/75; H01R 13/02; H01R 13/504; H01R 13/533; H01R 13/6581; H01R 13/6592

(52) U.S. Cl. CPC H01R 13/6273; H01R 11/28; H01R 12/722; H01R 12/75; H01R 13/025; H01R 13/504; H01R 13/533; H01R 13/6581; H01R 13/6592; H01R 2201/26

(57) ABSTRACT

A compact connector that economically provides high signal integrity in a harsh environment, such as an automobile, which may be a right-angle connector. The connector may include a contact carrier position assurance component (CCPA) that ensures that a contact carrier is and remains latched in a designed position, which improves signal integrity. The CCPA may retain the mating interface portions or the contact carrier in the desired location relative to the mating direction, but may be narrow and fit into a narrow slot perpendicular to the mating direction of the connector so as to enable the connector to extend only a small distance in the mating direction beyond the mating face of a mating connector. Such a connector may also have a connector position assurance device that facilitates reliable operation of the connector.

### BACKGROUND

This patent application relates generally to interconnection systems, such as those including electrical connectors, used to interconnect electronic assemblies, and more specifically to interconnection systems for harsh environments, such as in a vehicle.

Electrical connectors are used in many electronic systems. It is generally easier and more cost effective to manufacture a system as separate electronic assemblies, which may be joined together with electrical connectors. Connectors may be used for interconnecting assemblies so that the assemblies may operate together as part of a system. Connectors, for example, may be mounted on printed circuit boards within two assemblies that are connected by mating the connectors. In other systems, it may be impractical to join two printed circuit boards by directly mating connectors on those printed circuit boards. For example, when the system is assembled, those printed circuit boards may be separated by too great a distance for a direct connection between connectors mounted in the printed circuit boards.

In some systems, connections between assemblies may be made through cables. The cables may be terminated with connectors that mate with connectors mounted on a printed circuit board. In this way, connections between assemblies may be made by plugging a connector that is part of cable assembly into a connector that is mounted to printed circuit board. In other system architectures, a connector terminating a cable may be mated with another connector terminating another cable.

An example of a system in which assemblies are connected through cables is a modern automobile. For example, automotive vehicles include electronic control units (ECUs) for controlling various vehicle systems, such as the engine, transmission (TCUs), security system, emissions control, lighting, advanced driver assistance system (ADAS), entertainment system, navigation system, and cameras. The ECUs may be manufactured as separate assemblies and connected over one or more vehicle networks formed with cables routed between these assemblies. To simplify manufacture of an automobile, the assemblies may be formed separately and then connected via cables that are terminated with connectors that enable connections to mating connectors terminating other cables or attached to printed circuit boards within the assemblies.

An automobile presents a harsh environment for an electrical connector. The automobile may vibrate, which can cause a connector to unmated and cease working entirely. Even if the vibration does not completely prevent operation of the connector, it can cause electrical noise, which can interfere with operation of electronics joined through interconnects including connectors. Noise, for example, may result from relative movement of components within connectors, which can change the electrical properties of the connector. Variations in the electrical properties, in turn, cause variation in the signals passing through the interconnect, which is a form of noise that interferes with processing the underlying signal.

In an automotive environment, electrical noise might also arise from automotive components that generate electromagnetic radiation. That radiation can couple to the conductive structures of a connector, creating noise on any signals passing over those conductive structures. In an automobile, any of a number of components might generate electromagnetic radiation, such as spark plugs, alternators or power switches. Noise can be particularly disruptive for high-speed signals such as those used to communicate data over an automobile network.

### SUMMARY OF THE INVENTION

Concepts as disclosed herein may be embodied as an electrical connector, comprising (i) a housing (120) comprising a chamber and a first opening (128); (ii) a contact carrier comprising a mating portion extending in a first direction and a cable mounting portion extending in a second direction transverse to the first direction, (iii) wherein: (a) the mating portion is positioned within the chamber of the housing and engaged to the housing; (b) the mating portion comprises a tab (146); and (c) a position assurance component (130) configured to latch at a closed position within the first opening of the housing and at which the position assurance component engages the tab (146) of the contact carrier to hold the contact carrier within the chamber of the housing such that the position assurance component engages the contact carrier between the tab (146) and the cable mounting portion.

Optionally, the first opening may comprise a channel extending in the second direction Optionally, the position assurance component may be configured to slide in the channel between an open position and the closed position; and to latch to the housing in the open position. Optionally, the second direction is substantially perpendicular to the first direction. That is, the electrical connector may be a right-angle connector. Optionally, the position assurance component (130) may comprise a tab (136) that is configured to abut the tab (146) of the contact carrier when the position assurance component is in the closed position. Optionally, the position assurance component may comprise (i) a base (652), (ii) a first arm (650A) and (iii) a second arm (650B) extending from the base and configured to latch to the housing; wherein the tab (136) extends from the base. Optionally, the tab (136) of the position assurance component is thinner than the first arm and the second arm.

In another aspect, an electrical connector may comprise: (i) a housing (120) comprising a chamber, a first opening (128) and a latch (122); and (ii) a contact carrier comprising a mating portion extending in a first direction and a cable mounting portion extending in a second direction transverse to the first direction, (iii) wherein: (a) the mating portion is within the chamber of the housing, (b) the contact carrier comprises a projection; and (c) the latch (122) engages the projection to latch the contact carrier within the chamber of the housing; and (iv) a position assurance component (130) positioned within the first opening of the housing and configured to slide into a closed position at which the position assurance component blocks withdrawal of the contact carrier from the chamber of the housing.

Optionally, the housing may comprise an insulative housing (160) and the latch may comprise an arm integrally molded with the insulative housing. Optionally, the electrical connector may further comprise: (i) a conductive housing (150); (ii) wherein the contact carrier comprises (a) an insulative housing comprising a channel and a contact disposed within the channel; and (b) the conductive housing comprises the projection of the contact carrier. Optionally, the conductive housing is a die cast member; and the conductive housing comprises an integrally formed portion of the die cast member.

In yet another aspect, a cable assembly comprises: (i) a cable comprising a conductor; (ii) an electrical connector (100), comprising: (a) an outer housing (120) comprising a chamber; (b) a conductive housing (150) comprising a portion comprising a chamber at least partially positioned within the chamber of the outer housing; (c) an insulative housing comprising a channel disposed within the chamber of the conductive housing; (d) a contact comprising a mating portion disposed within the channel of the insulative housing and a tail attached to the conductor of the cable, wherein the conductive housing further comprises a tail (152) configured to support the cable.

Optionally, the cable assembly may further comprise (i) an integral sheet comprising a first portion at least partially encircling the tail and the cable. Optionally, the integral sheet comprises an outer ferrule; the electrical connector further comprises an inner ferrule disposed over the cable; and the first portion of the integral sheet at least partially encircles the tail, the cable and the inner ferrule. Optionally, the cable comprises a jacket and a shield; the cable shield extends beyond the jacket and is disposed between the inner ferrule and the outer ferrule. Optionally, the tail comprises a stepped portion extending toward the cable; and an end of the cable shield is between and in contact with the stepped portion and the cable jacket. Optionally, the inner ferrule comprising a first portion with a circular cross-section and a second portion comprising an oval cross-section; and the first portion of the integral sheet at least partially encircles the tail, the cable and the first portion of the inner ferrule such that the shield is between and in contact with the inner ferrule and the outer ferrule over substantially all of a circumference of the first portion of the inner ferrule.

Optionally, the integral sheet comprises a second portion; and the second portion at least partially encircles the cable at a location offset from the tail.

Optionally, the chamber of the conductive housing comprises an entrance; the integral sheet comprises a third portion covering the entrance. Optionally, the conductive housing comprises at least one embossment holding the third portion to the conductive housing. Optionally, the third portion comprises a planar portion and an embossed region offset from the planar portion. Optionally, the mating portion of the contact is elongated in a first direction and the tail extends in a second direction, perpendicular to the first direction; the conductor of the cable comprises a distal portion extending in the second direction within the conductive housing; and the distal portion of the conductor is adjacent to the embossed region of the third portion. Optionally, the embossed region extends into the chamber of the conductive housing; and the inner ferrule is outside the chamber of the conductive housing.

In yet another aspect, a housing subassembly for an electrical connector comprises (i) an insulative housing (120) comprising a latch and a channel; and (ii) a connector position assurance device (CPA) (110) disposed within the channel, (iii) wherein: (a) the CPA comprises: (1) a compliant arm comprising a protrusion (112) extending therefrom; and (2) a distal portion; and (b) the insulative housing further comprises a stop (729) disposed within the channel and configured to engage the camming surface of the protrusion to urge the protrusion into a predetermined position; and (c) the housing subassembly is configured such that a portion of the insulative housing blocks motion of the CPA within the channel beyond the predetermined position.

Optionally, the complaint arm is a first compliant arm and the CPA further comprises a second compliant arm, parallel to the first compliant arm. Optionally, the CPA further comprises: (i) a first cross member connecting a first end of the first compliant arm and the second compliant arm and (ii) a second cross member connecting a second end, opposite the first end of the first compliant arm and the second compliant arm. Optionally, the stop may be a first stop and the projection is a first projection; the CPA comprises a second projection on the compliant arm; and the insulative housing comprises a second stop disposed within the channel and configured to engage the second protrusion to block motion of the CPA within the channel in the first direction when the CPA is in an unlocked position at which the CPA is clear of the latch.

### BRIEF DESCRIPTION OF DRAWINGS

The accompanying drawings are not limited to the dimensions shown. For purposes of clarity, not every component may be labeled in every drawing. In the drawings:

FIG. 1 is a perspective view of an illustrative interconnection system including a board connector 100 and a cable connector 200′mated to the board connector.

FIG. 2A is an exploded perspective view of an illustrative right angle cable connector 200 that may mate with the board connector 100 of FIG. 1.

FIG. 2B is a series of sketches illustrating exemplary steps of a method 200 for terminating a cable 300 with an illustrative cable connector 200 as shown in FIG. 2A to manufacture a cable assembly.

FIG. 2C is a side view of cable connector 200 formed by the manufacturing process of FIG. 2B.

FIG. 3A is an enlarged view of a cable with a ferrule and a braid during steps of the manufacturing process of FIG. 2B.

FIG. 3B is a cross-sectional view of the illustrative cable of FIG. 3A along the line A-A.

FIG. 3C is a cross-sectional view of the illustrative cable of FIG. 3A along the line B-B.

FIG. 3D is a sectional view of a portion of the illustrative cable connector 200 of FIG. 2A showing a portion of the cable termination.

FIG. 4A is a perspective view of an illustrative insulative housing and electrical contacts of a right-angle contact carrier of the illustrative cable connector 200 showing a housing.

FIG. 4B is a top sectional view of the illustrative housing and electrical contacts of FIG. 4A.

FIG. 4C is a cross-sectional view of the illustrative housing and electrical contacts of FIG. 4A with a TPA 170 installed.

FIGS. 5A, 5B and 5C are perspective views of an illustrative right angle contact carrier, at successive steps in a manufacturing process, showing, respectively, a conductive housing, the conductive housing with insulative housing inserted and contacts terminating a cable in the insulative housing, and a sectional view along line C-C of FIG. 5B of the contact carrier.

FIG. 5D is a cross-sectional view of the illustrative right angle contact carrier of FIG. 5C.

FIG. 6A is a side, perspective view of the illustrative contact carrier of FIG. 5C being inserted into a housing subassembly.

FIG. 6B is a perspective view of a portion of an illustrative contact carrier.

FIG. 6C is a cross-section view of the illustrative cable connector 200 with the contact carrier locked in place by contact carrier position assurance component (CCPA) 130.

FIG. 6D is a perspective view of an illustrative CCPA.

FIG. 6E is a perspective view of the illustrative cable connector 200, showing a latch and CCPA.

FIG. 7A is an enlarged side view of a portion of the illustrative housing subassembly of cable connector 200 with a connector position assurance component (CPA).

FIG. 7B is a perspective view of the illustrative connector position assurance (CPA) component of FIG. 7A.

FIG. 7C is a sectional view of the illustrative cable connector housing subassembly of FIG. 7A, taken along line 7C-7C, with the illustrative CPA in a first, unlocked position.

FIG. 7D is a sectional view of the illustrative cable connector housing subassembly of FIG. 7A, taken along line 7C-7C, with the illustrative CPA in a second, locked position.

FIG. 7E is a top, perspective view of the illustrative housing subassembly of FIG. 7A with the CPA in the second, locked position.

### DETAILED DESCRIPTION

The inventors have recognized and appreciated techniques for making a connector for providing high data rate transmission that may be economically manufactured yet operate reliably in the harsh environment presented by an automobile. Such a connector would be suitable for interconnecting assemblies in an automotive network, for example.

These techniques may be applied in a modular connector system in which a set of components may be combined to form connectors in any of multiple configurations. The cost associated with manufacturing connectors of the types described herein may be reduced by designing the parts of the connectors to be modular.

The inventors have recognized and appreciated various techniques that may be applied to the components of the connector system to provide connections with high signal integrity (SI). The SI improvements may result from controlling the electrical properties of the signal paths through the connector and/or from configuring the connector to operate effectively, notwithstanding the rugged automotive environment in which the connector is used. Techniques disclosed herein may provide for mechanical and/or electrical stability of electrical conductors within a connector. These techniques may be used to manufacture a right-angle cable connector that is both robust and compact, while high SI.

For example, one connector configuration may be formed from an insulative outer housing that establishes at least a mating interface of the connector. The insulative outer housing may provide latching features. The set of components may include insulative outer housings in complementary configurations, which may be used to form two connector configurations that will mate and latch to each other. The insulative housing may comprise a chamber and a channel.

A cable connector may be assembled by inserting one or more contact carriers, each terminating one or more cables into the chamber of the insulative housing. The contact carriers may have a tab that aligns with a channel in the connector housing. A latching feature of the insulative housing may engage with the contact carrier to hold it within the housing. Alternatively or additionally, a contact carrier position assurance component (CCPA) may ensure that the contact carriers of the connector are properly positioned in the connector and remain properly positioned during use of the connector, despite shock and vibration that might otherwise tend to dislodge the contact carriers from their intended position. Ensuring the contact carriers are securely retained in their designed positions reduces impedance discontinuities in a mated pair of connectors and reduces vibration induced noise.

A CCPA may have a design that facilitates simple and reliable manufacture of a connector. The CCPA may be latched to the insulative housing in any of multiple positions. The multiple positions may be, for example, an open position and a closed position. The CCPA may enable a contact carrier to be inserted into the insulative housing while the CCPA is in an open position. Moving the CCPA into a closed position may lock those multiple contact carriers in place.

For example, one connector configuration may be embodied as a right-angle connector so as to be compact and fit within a constrained space. Such a connector may comprise a housing comprising a chamber and a first opening; a contact carrier comprising a mating portion extending in a first direction and a cable mounting portion extending in a second direction transverse to the first direction, such that the mating portion is positioned within the chamber of the housing and engaged to the housing; the mating portion comprises a tab; and a position assurance component is configured to latch at a closed position within the first opening of the housing and at which the position assurance component engages the tab of the contact carrier to hold the contact carrier within the chamber of the housing such that the position assurance component engages the contact carrier between the tab and the cable mounting portion.

Another connector configuration may comprise a housing comprising a chamber, a first opening and a latch; and a contact carrier comprising a mating portion extending in a first direction and a cable mounting portion extending in a second direction transverse to the first direction, such that the mating portion is within the chamber of the housing, the contact carrier comprises a projection; and the latch engages the projection to latch the contact carrier within the chamber of the housing; and a position assurance component is positioned within the first opening of the housing and configured to slide into a closed position at which the position assurance component blocks withdrawal of the contact carrier from the chamber of the housing.

A cable assembly may comprise: a cable comprising a conductor; an electrical connector comprising: an outer housing comprising a chamber; a conductive housing comprising a portion comprising a chamber at least partially positioned within the chamber of the outer housing; an insulative housing comprising a channel disposed within the chamber of the conductive housing; a contact comprising a mating portion disposed within the channel of the insulative housing and a tail attached to the conductor of the cable, wherein the conductive housing further comprises a tail configured to support the cable.

In addition, a subassembly for an electrical connector may comprise: an insulative housing comprising a latch and a channel; and a connector position assurance device (CPA) disposed within the channel, such that the CPA comprises: a compliant arm comprising a protrusion extending therefrom; and a distal portion; and the insulative housing further comprises a stop disposed within the channel and configured to engage the protrusion to block motion of the CPA within the channel in a first direction when the CPA is in a locked position at which the CPA blocks motion of the latch; and the housing subassembly is configured such that a portion of the insulative housing blocks motion of the CPA within the channel in a second direction, opposite the first direction, when the CPA is in the locked position.

Techniques as described herein may be used singly or in combination. These techniques are illustrated below in connection with an interconnection system that may be used, for example, to make physical connections between assemblies in an automobile.

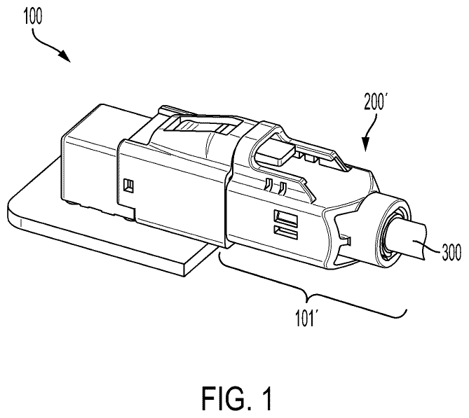

FIG. 1 is a perspective view of an illustrative interconnection system including a board connector 100 and a cable connector 200′ mated to the board connector. The interconnection system may be used to connect two electronic devices to one another. In some embodiments, interconnection system 100 is used in high data rate transmission applications (e.g., in applications including ECUs of automotive vehicles). In this example, the interconnection system comprises a board connector 100 and a cable connector 200′. In this example, cable connector 200′ has an elongated orientation, in which cable 300 exits a housing of connector 200′ from the rear, in a direction opposite the direction into which cable connector 200′ is inserted into board connector 100 for mounting. A cable connector with the configuration illustrated in FIG. 1 is usable only in the systems in which there is a clearance space 101′ in front or board connector 100 that exceeds the length of cable connector 200′ by a sufficient distance to accommodate cable 300 when bent at its minimum bend radius.

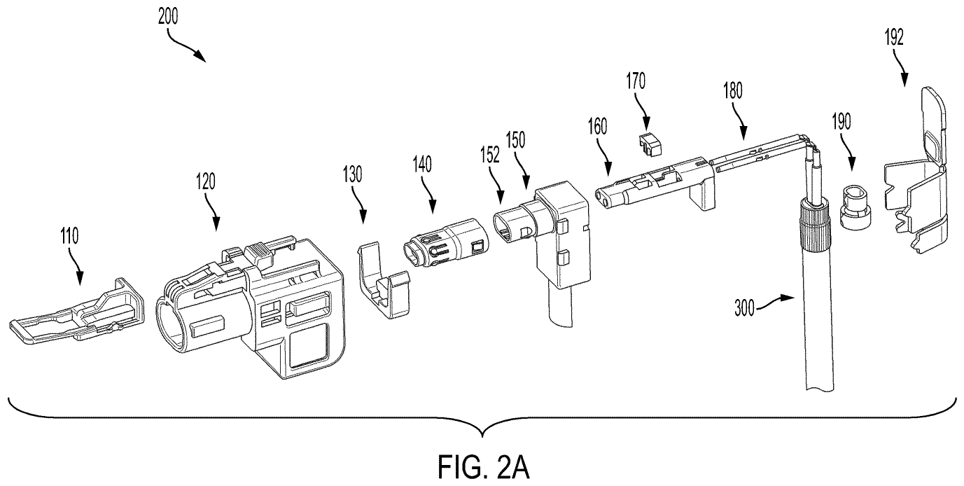

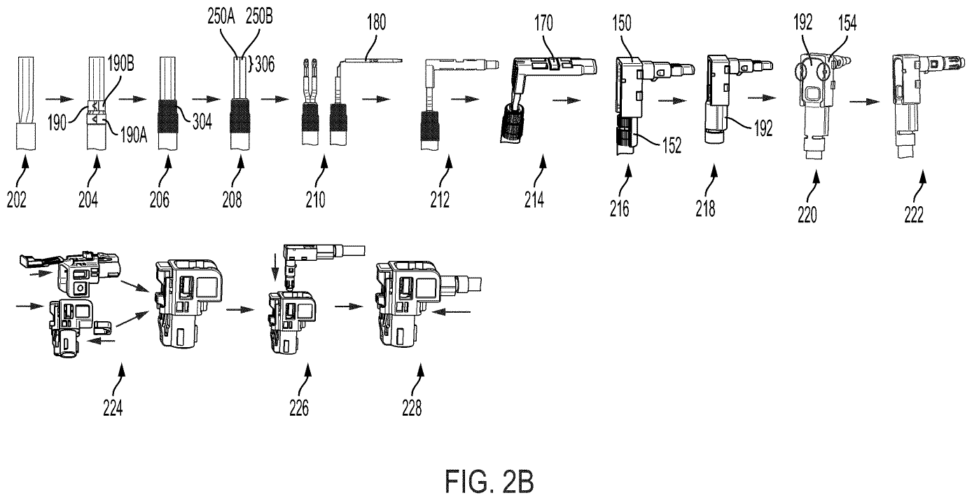

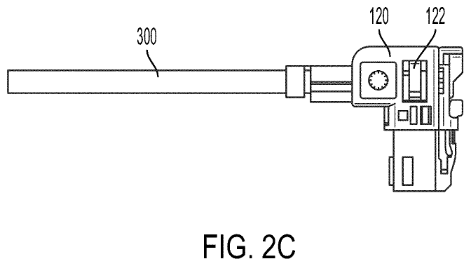

In some scenarios, however, clearance space may be insufficient to accommodate a cable connector 200′and cable 300 without bending cable 300 into a tighter radius than its minimum bend radius. For example, board connector 100 may be mounted in a panel of an ECU that is adjacent a wall of an automobile such that clearance space 101′ is constrained. In such a scenario, a compact right angle cable connector 200 (FIG. 2A) may be used. Such a compact connector, nonetheless, may have a mating interface like cable connector 200′ to enable mating with the same board connector. Similarly, the compact cable connector may have ruggedness and SI comparable to connector 200′such that performance of the system is not degraded by using a compact connector.

FIG. 2A is an exploded perspective view of an illustrative right angle cable connector 200 that may mate with board connector 100 of FIG. 1. Right angle cable connector 200 may include a plug housing 120, which may be manufactured, such as by injection molding from insulative material, such as plastic or nylon. Cable connector 200 may also include a connector position assurance (CPA) component 110 engaged with the plug housing 120.

Cable connector 200 may also include a conductive housing 150. Conductive housing 150 may be a die cast component, for example. In this example, conductive housing has a forward portion 152 that extends into an opening of plug housing 120 when the conductive housing 150 is inserted into the plug housing 120.

Cable connector 200 also may include one or more additional shield members, here illustrated as front shield 140. The front shield 140 may fit over forward portion 152 of the conductive housing 150 so that both the forward portion 152 of the conductive housing 150 and the front shield 140 extend into the opening of plug housing 120, to further encircle the electrical conductors 180. Shield 140 is electrically and mechanically coupled to conductive housing 150 such that shield 140 may also be grounded.

The front shield 140 may fit over the forward portion 152 of the conductive housing 150 so that both the forward portion 152 of the conductive housing 150 and the front shield 140 extend into the opening of plug housing 120. Front shield 140 may be formed from a sheet of metal to provide shielding and may include one or more features to provide one or more functions. For example, one or more features stamped in the sheet of metal forming front shield 140 may hold the front shield 140 to conductive housing 150, mate the front shield 140 to a corresponding conductive structure in board connector 100, or provide one or more tabs that engage with CCPA 130.

Some of the components of cable connector 200 may be assembled into a contact carrier, which may include electrical conductors 180 that may serve as signal conductors. In this example, the contact carrier is assembled with components that hold and shield electrical conductors 180 and provide a controlled impedance environment for electrical conductors 180. In this example, conductive housing 150 form a portion of a contact carrier.

In this example, a pair of electrical conductors 180 is shown such that the contact carrier is configured for passing a differential signal. In addition to transmitting one or more signals through the connector, the electrical conductors may have a mating contact portion at one end, a tail at the opposite end and an intermediate portion therebetween. Accordingly, the electrical conductors may serve as contacts for the connector. In this example, the mating contact portions of the electrical conductors are shaped as receptacles, which may receive and mate to mating contact portions of conductors (not shown) shaped as pins in board connector 100. In other examples, the mating contact portions of the electrical conductors in cable connector 200 may be shaped as pins, blades or have other shapes.

In this example, the tails of electrical conductors 180 are configured to be attached to conductors within cable 300. Conductors within cable 300, for example, may be soldered to the tails of electrical conductors 180. In the example of FIG. 2A, the mating contact portions and the tails of electrical conductors 180 are joined by an intermediate portion that bends through a right angle. As a result, cable 300 terminated to the electrical conductors 180 extends from connector 200 perpendicular to the mating direction in which connector 200 may be inserted into board connector 100 for mating.

A ferrule 190 may also be included in the contact carrier to facilitate termination of cable 300 to the contact carrier. In FIG. 2A, ferrule 190 is shown exploded relative to its designed position. Ferrule 190, for example, may be annular with conductors of cable 300 passing through an opening of ferrule 190. A shield of the cable may be folded over ferrule 190 and captured between ferrule 190 and outer ferrule 192 when ferrule 192 is installed.

A contact carrier may also include an insulative inner housing 160 holding the mating contact portions of the electrical conductors 180. The insulator may be shaped and sized to receive the mating contacts. For example, the contacts 180 may pass through openings of insulative inner housing 160. The insulative housing 160 can be inserted into a cavity within conductive housing 150. In this way, conductive housing 150 will at least partially encircle the insulative inner housing 160, including the electrical conductors 180 therein.

A contact carrier may also include a terminal position assurance (TPA) component 170, which may be inserted into insulative inner housing 160 to secure the electrical contacts 180 within the insulative inner housing 160.

A contact carrier may further include a mechanism to connect conductive housing 150 to ground. In this example, outer ferrule 192 (shown in an un-formed state in FIG. 2A) may connect a shield of cable 300 to conductive housing 150. By grounding conductive housing 150, it may serve as a shield for the contact carrier, including the pair of conductors 180 therein.

Cable connector 200 may also include a contact carrier position assurance component (CCPA) 130, which provides precise and stable positioning of conductors, such as contacts 180. The CCPA 130 ensures that the contact carrier is and remains latched in a designed position. The contact carrier position assurance component may slide into a closed position, locking a contact carrier into the designed position.

FIG. 2B is a series of sketches illustrating exemplary steps of a method 200 for terminating a cable 300 with an illustrative cable connector 200 as shown in FIG. 2A to manufacture a cable assembly. In the example of FIG. 2B, the cable is first prepared for termination. A cable, for example, may include one or more insulated conductors. In the illustrated example, cable 300 includes two insulated conductors 250A and 250B that will ultimately be attached to the contacts 180. These conductors may be surrounded by one or more layers that provide desired electrical and/or mechanical properties to the cable. Some or all of these layers may be removed at one end of the cable and/or exposed so that they may be connected, electrically and/or mechanically to structures in the cable connector.

The insulated conductors, for example, may be wrapped with a foil. The foil may be a thin metal foil backed by a polymer, such as mylar. The foil may mechanically hold the insulated conductors together and/or provide electrical shielding for the insulated conductors and/or provide a conducting ground path through the cable.

Instead of or in addition to the foil, the cable may include a layer formed from a wire braid. The wire braid may provide mechanical integrity to the cable, shielding for the insulated conductors and a ground path. In this example, a foil and braid are used, with the foil forming an inner layer and the braid forming an outer layer.

A cable may include an outer layer forming a jacket for the cable. The jacket may be an insulative polymer that provides mechanical protection for the cable.

In step 202, a jacket of cable 300 is stripped off, which in this example exposes the braid 304 and the foil under the braid.

In step 204, the inner ferrule 190 is threaded onto the cable and crimped in place. In the example of FIG. 2B, ferrule 190 has two connected portions. A larger diameter portion 190A is crimped over a portion of the cable with the jacket still in place. A smaller diameter portion 190B is crimped over a portion of the cable in which the braid 304 has been exposed.

In step 206 the braid 304 in the portion of the cable extending beyond smaller diameter portion 190B is turned back over ferrule 190. In this state, the outermost layer in the portion of the cable between ferrule 190 and the end is the foil.

In step 208, the foil in the portion of the cable extending beyond ferrule 190 is cut away to expose the insulated conductors 250A and 250B. A portion 306 of the insulator at the ends of insulated conductors 250A and 250B may also be removed, exposing the ends of the conductors of the cable.

In step 210, contacts 180 may be crimped to the exposed ends of the conductors of the cables. The contacts 180 may then be bent such that the mating portion of the contact extends in a first direction and the tail of the contact, to which cable conductor is attached extends in a second direction, perpendicular to the first direction.

In step 212, the contacts 180 are inserted into the inner housing 160. In step 214, TPA 170 is inserted into the inner housing 160 to secure the contacts 180 within the inner housing 160.

In step 216, the conductive housing 150 is assembled over the insulative housing 160. Conductive housing 150 includes a tail 152 that is aligned with the portion of the cable 300 including inner ferrule 190. The portion of braid 304 folded over ferrule 190 is therefore in contact with conductive housing 150 at tail 152.

In step 218, a metal sheet that forms outer ferrule 192 is wrapped around tail 152 and inner ferrule 190. The sheet is crimped in this location providing mechanical connection of the cable to conductive housing 150. Alternatively or additionally, braid 304 may be electrically connected to conductive housing 150 by this crimping operation.

As part of the assembly process, an opening in conductive housing 150 through which insulative housing 160 is inserted may be covered. In the example of FIG. 2B, the metal sheet that forms outer ferrule 192 has a portion that aligns with that opening and covers it. In step 220, embossments 154 are formed on each side of the conductive housing 150 as shown in the figure. Embossments 154 may be formed in a pounding operation, for example, and may hold the portion of the metal sheet forming outer ferrule 192 to conductive housing 150.

In step 222, a front shield 140 is positioned over the forward portion 152 of the conductive housing 150. Tabs or other features on front shield 140 may engage with recesses or other complementary features on conductive housing 150.

A cable connector as described herein may be assembled from a housing subassembly, which may be assembled as part of the cable termination process or may be assembled at a different time and/or in a different location. A connector manufacturer, for example, may supply the housing subassembly as part of a kit including some or all of the connector components shown in FIG. 2A. Step 224 illustrates assembly of the subassembly. In step 224, CCPA 130 is slid into the plug housing 120 and CCPA 130 is latched to plug housing 120 in a first position. In the illustrated state, CCPA 130 is latched in the first, open position where it will not block motion of a contact carrier into the housing 120. CPA 110 is also slid into the plug housing 120 and latched in an open position. In the open position, CPA 110 is held away from a latching member, which can latch the cable connector to a mating connector. In the open position, the latching member may move, enabling latching and/or unlatching of the cable connector to a mating connector.

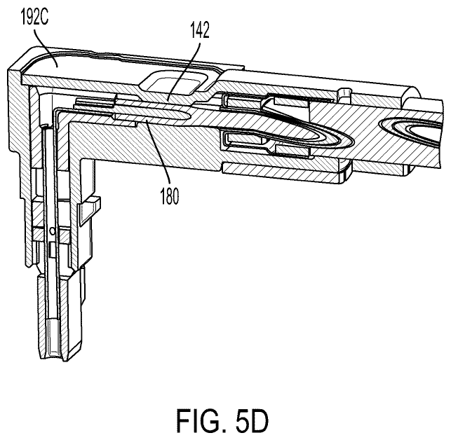

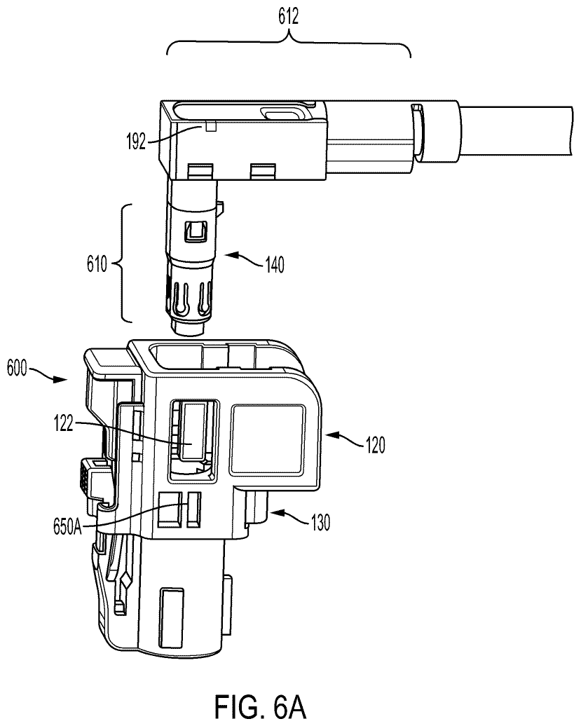

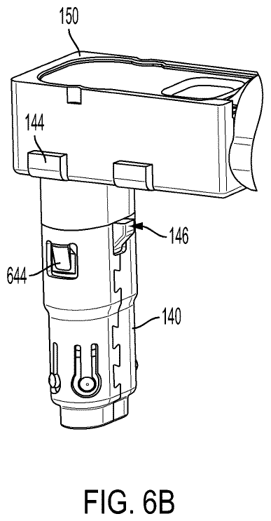

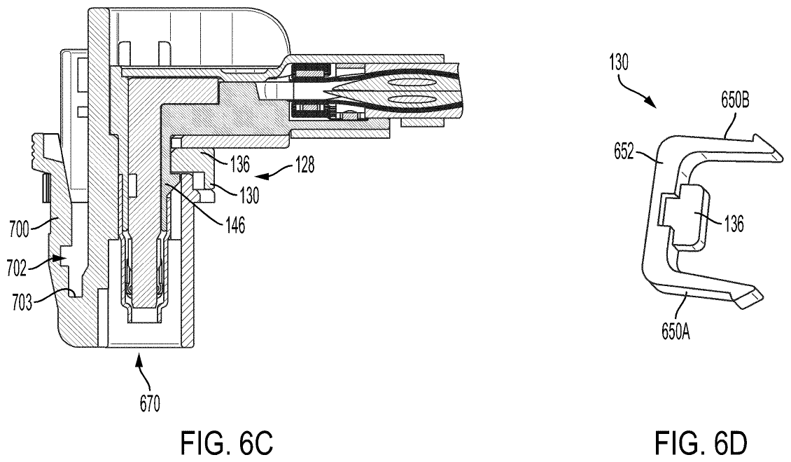

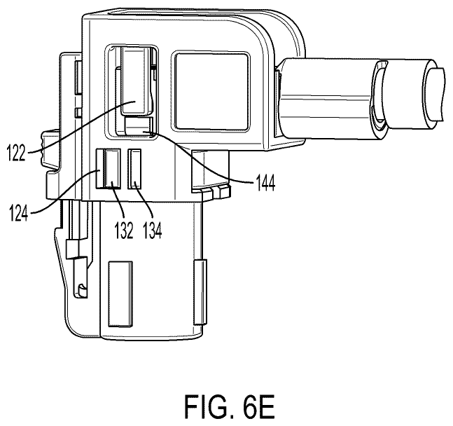

In step 226, the assembled contact carrier comprising the front shield 140, conductive housing 150, inner housing 160, TPA 170, and contacts 180 are posited within the right angle plug housing 120. A latching member 122 on plug housing 120 may engage to contact carrier assembly, such as to engage a projection 144 as can be seen in FIG. 6E, to hold it in the housing. Additional ruggedness may be obtained using a CCPA, to prevent withdrawal of contact carrier from the housing and to provide an indication that the contact carrier is positioned in its intended location within housing 120. In step 228, CCPA 130 is slid from its open position into a second, closed position within the plug housing 120. If contact carrier is not fully seated in its designed position, as CCPA 130 slides towards the closed position, portions of the contact carrier may block motion of the CCPA 130. Consequently, if the contact carrier is out of position, force above a threshold may be required to slide CCPA 130 to the closed position, and the high force may provide feedback to the user that the contact carrier is not properly positioned in the housing subassembly. Conversely, if CCPA 130 slides into the closed position, it will interfere with a tab or other structure on the contact carrier to thereby secure the contact carrier within the plug housing 120.

FIG. 2C shows the resulting cable assembly formed by performing the steps of the method 200 of FIG. 2B. FIG. 2C shows one end of the cable assembly. An opposite end of the cable assembly may be terminated in other ways, such as with another connector or by direct connection of the conductors within cable 300 to other electronic components.

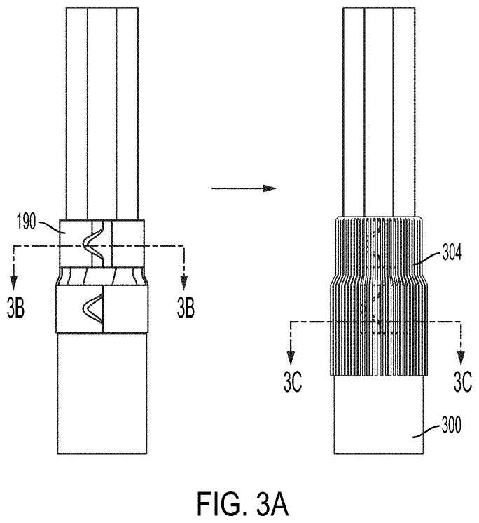

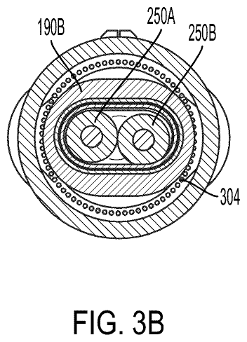

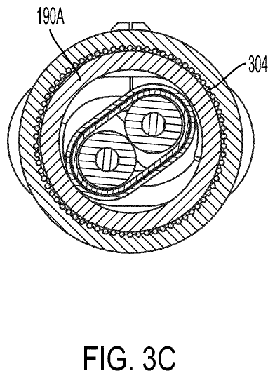

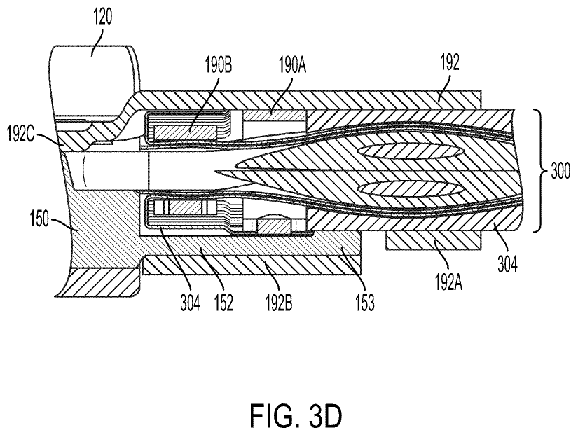

Additional details of the construction and operation of these components of the cable assembly are illustrated in the following figures. FIG. 3A illustrates a cable having a first part and a second part with an inner ferrule 190 and a braid 304. As explained with respect to step 206 of the method 200 illustrated in FIG. 2B, the braid 304 is turned back. FIG. 3B is a cross-sectional view of the first part of the illustrative cable of FIG. 3A along the line A-A. FIG. 3C is a cross-sectional view of the second part of the illustrative cable of FIG. 3A along the line B-B.

As shown in FIG. 3B, the illustrative cable comprises the insulated conductors 250A and 250B encompassed by a first portion 190B of the inner ferrule 190 having an oval cross section. As shown in FIG. 3C, a second part of the illustrative cable comprises the insulated conductors 250A and 250B encompassed by a second portion 190A of the inner ferrule 190 having a circular cross section.

FIG. 3D is a sectional view of the cable attachment to an illustrative cable connector. As shown in FIG. 3D, the conductive housing 150 comprises a tail 152 extending parallel to the axis of cable 300. Tail 152 includes a step 153. In this example, step 153 is on the portion of tail 152 that extends beyond inner ferrule 190. In the state illustrated, braid 304 is folded back over ferrule 190 and may extend beyond inner ferrule 190 such that step 153 ensures that the conductive housing 150 presses against the braid 304 at its free end. In this example, step 153 captures braid 304 between tail 152 and the jacket of cable 300.

Additional structure of outer ferrule 192 is also visible in FIG. 3D. In this example, outer ferrule 192 has multiple portions, which are integrally formed from a single sheet of metal. A portion 192A is in contact with and crimped around cable 300. Portion 192A, for example, may press against the jacket of cable 300. Portion 192A may provide mechanical connection between the connector and the cable.

A second portion 192B encircles a portion of the cable including inner ferrule 190 and the tail 152 of the conductive housing. In this example, portion 192B presses against tail 152 over a portion of its circumference. Over the rest of its circumference, it presses against braid 304 that is folded back over inner ferrule 190. Portion 192B may provide mechanical and electrical connection between the cable and the connector, as it may attach the cable to the tail 152 and presses tail 152 of the conductive housing 150 into braid 304, which makes an electrical connection.

A third portion 192C extends over an opening in conductive housing 150 and can form a cover for conductive housing 150.

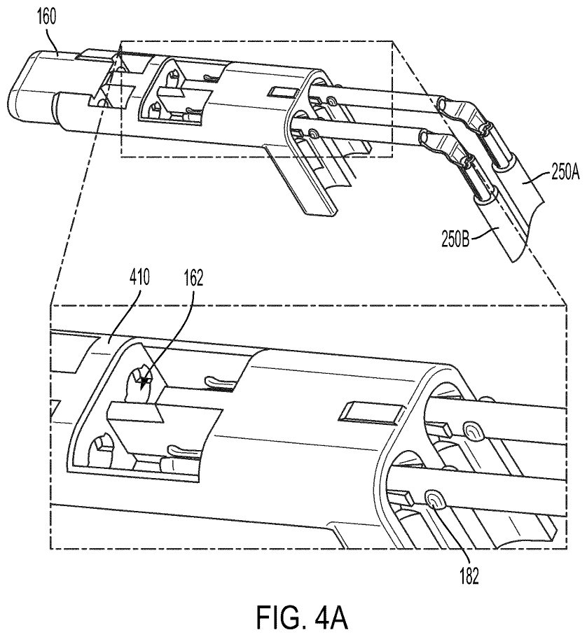

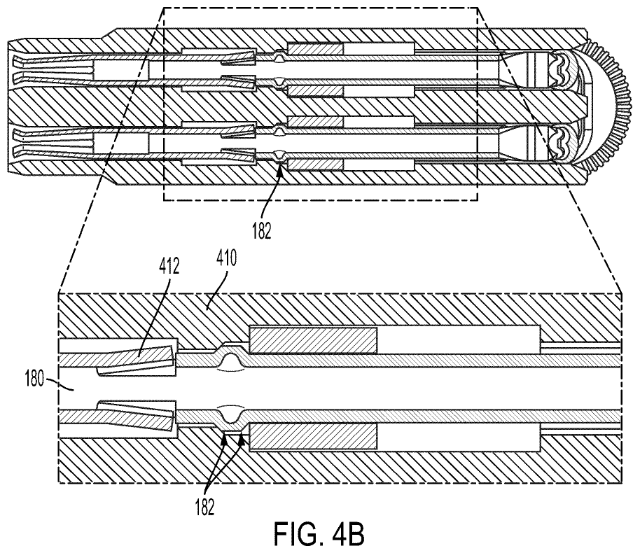

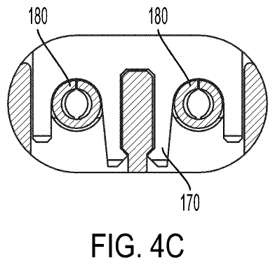

FIG. 4A is a perspective view of an illustrative insulative inner housing 160 into which electrical contacts 180 are inserted. In this example, insulative inner housing 160 is L-shaped, with channels, extending in two orthogonal directions to receive electrical contacts 180 after they are bent, as described above in connection with step 210.

FIG. 4A illustrates electrical contacts 180 partially inserted into inner housing 160. FIG. 4B is a top sectional view, illustrating electrical contacts 180 fully inserted into inner housing 160. As can be seen, electrical contacts 180 have features that engage with an interior wall 410 of inner housing 160. Interior wall 410 has a hole through which the contact 180 is inserted. Contact 180 include features that engage two sides of wall 410, locking the contact in an axial direction with respect to wall 410.

In this example, those features include spring fingers 412, cut from contact 180. Spring fingers 412 may be pressed into the body of contact 180 for insertion of contact 180 through the hole in wall 410 and may spring outwards on a second side of the wall, to prevent the contact 180 from being withdrawn through the hole from a designed location. Alternatively or additionally, contact 180 may have dimples 182. The dimples fit within slots 162 on the first side of the wall. Interference between the dimples and the first side of the wall prevent insertion of contact 180 beyond its designed location.

FIG. 4C is a cross-sectional view of the illustrative insulative housing of FIG. 4A. As shown in these figures, the dimples 182 are disposed in slots 162. Engagement of the dimples and the slots also blocks rotation of contact 180 from its designed orientation.

In this example, the electrical contact 180 has a mating portion elongated in a first direction and a tail portion extending in a second direction, perpendicular to the first direction, as shown in FIG. 4A. The mating portion of the electrical contact 180 slides through a channel in the inner housing 160 such that the dimple 182 of the electrical contact 180 is disposed in the slot 162. Optionally, the contact carrier may also include a terminal position assurance component (TPA) 170 positioned to block withdrawal of the dimple 182 from the slot 162, as shown in FIGS. 4B and 4C. In this example, TPA 170 includes two compliant arms that latch under shelf in the inner insulative housing,

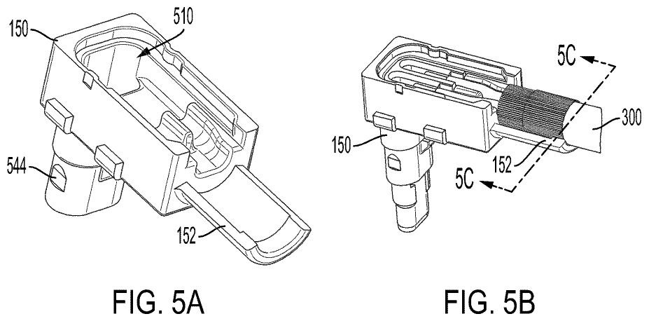

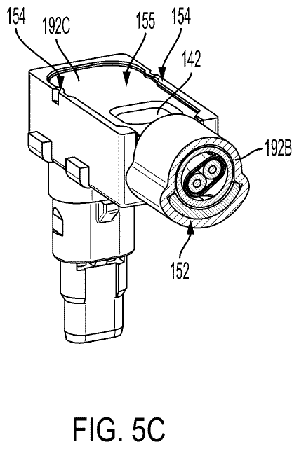

FIG. 5A . . . 5D illustrate further details of the assembly of the insulative housing, with contacts 180 secured in it, into conductive housing 150. FIGS. 5A, 5B and 5C are perspective views of an illustrative right angle contact carrier. As shown in these figures, the conductive housing 150 may have a chamber 510 that receives the insulative housing.

Conductive housing 150 may be open at the back, providing an entrance into chamber 510 through which the insulative housing may be inserted. An integral sheet from which outer ferrule 192 is formed may have a third portion 192C covering the entrance after the insulative housing is inserted. Optionally, the conductive housing 150 may comprise at least one embossment 154 extending into the entrance to the conductive housing 150, blocking removal of portion 192C. Embossments 154 may be formed by pounding that deforms conductive housing 150, for example, after portion 192C is put in place to cover the entrance. Alternatively, conductive housing 150 may be formed, such as by die casting, with embossments 154 before portion 192C is placed over the entrance. In this later scenario, portion 192C may be slid into position under the embossments 154. Optionally, embossments 154 may be positioned on opposite sides of the conductive housing 150, as also shown in FIG. 5C.

The third portion of the integral sheet may comprise a planar portion 155 and a region 142 offset from the planar portion, as illustrated in FIG. 5C. In this example, region 142 may be formed by embossing the metal sheet. Embossed region 142 may improve signal integrity in the electrical contacts 180. As shown in FIG. 5D, which is a cross-sectional view of an illustrative right angle contact carrier, embossed region 142 changes the spacing between contact 180 and portion 192C. As outer ferrule 192 is grounded, embossed region 142 changes the signal to ground spacing in a limited region of contact 180. Such a configuration may compensate for impedance changes that would otherwise arise from the crimp of the contact 180 to the conductor of the cable, or other features that, absent compensation, might result in n impedance change that would degrade signal integrity.

Optionally, the electrical contact 180 of the cable 300 comprises a distal portion extending into the conductive housing 150 and this distal portion is adjacent to the embossed region 142 of the third portion of the integral sheet, as shown in FIGS. 5B and 5C. Optionally, the embossed region 142 extends into the chamber 510 of the conductive housing 150 and the inner ferrule 190 is outside the chamber of the conductive housing.

Based on the foregoing description, may understand that optionally, an integral sheet includes a first portion that at least partially encircles the tail of the electrical contacts 180 and the cable 300. Optionally, the integral sheet comprises an outer ferrule 192. Optionally, an inner ferrule 190 is disposed over the cable 300. Preferably, the first portion of the integral sheet at least partially encircles the tail of the electrical contacts 180, the cable 300, and the inner ferrule 190. Optionally, the cable 300 comprises a jacket 302 and a shield, which may extend beyond the jacket and may be disposed between the inner ferrule 190 and the outer ferrule 192. Optionally, the tail of the electrical contacts 180 comprises a stepped portion extending toward the cable 300 wherein an end of the cable shield is between and in contact with the stepped portion and the cable jacket 302.

Optionally, the first portion of the integral sheet at least partially encircles the tail of the electrical contacts 180, the cable 300 and the first portion of the inner ferrule 190 such that the shield is between and in contact with the inner ferrule 190 and the outer ferrule 192 over substantially all of a circumference of the first portion of the inner ferrule 190.

Optionally, the integral sheet comprises a second portion that at least partially encircles the cable 300 at a location offset from the tail of the electrical contacts 180.

FIG. 6A is a side, perspective view of the illustrative contact carrier of FIG. 5C being inserted into a housing subassembly 600. As shown in this figure, the contact carrier is an assembly with electrical contacts 180 shielded by the front shield 140, conductive housing 150, and outer ferrule 192 and terminated to cable 300. This subassembly is inserted through the rear of the right angle plug housing 120 to position the front shield 140, which encircles the mating contact portions of contacts 180, at a mating interface of the connector. As further shown in FIG. 6A, the contact carrier comprises a mating portion 610 extending in a first direction and a cable mounting portion 612 extending in a second direction transverse to the first direction such that the mating portion is positioned within a chamber of the right angle plug housing 120 and is engaged to the plug housing 120 via latch 122.

Housing subassembly 600 may include a contact carrier position assurance component (CCPA) 130. In the example of FIG. 6A, CCPA is latched at a first portion in housing subassembly 600 in which a portion of CCPA extends from housing 120. This first position is an open position in which portions of CCPA 130 that could block motion of the contact carrier into or out of housing subassembly 600 are withdrawn a sufficient distance that they do not interfere with movement of the contact carrier.

FIG. 6B is a perspective view of a portion of the illustrative contact carrier of FIG. 6A. FIG. 6B shows front shield 140 held to insulative housing with a tab 644 bent into a recess 544 (FIG. 5A) of the conductive housing 150. Tab 644, for example, may be cut from a sheet of metal formed into front shield 140. Though only one such tab is shown, the contact carrier may have two or more such features to retain front shield 140 to conductive housing 150.

The contact carrier may include one or more other features that position and/or secure the contact carrier in a designed location. For example, FIG. 6B shows that the contact carrier includes a tab 146. Tab 146 may engage CCPA 130 when mating portion 610 is inserted into housing subassembly 600 into its designed location and CCPA 130 is pushed into a closed position. Tab 146 is, in this example, formed as part of conductive housing 150. Conductive housing, for example, may be formed by die casting and tab 146 may be formed as part of that operation. Alternatively, a tab may be formed from the metal sheet used to form front shield 140.

FIG. 6C is a cross-section view of the illustrative cable connector 200 with the contact carrier locked in place by CCPA 130. As can be seen in this example, CCPA 130 is inserted in a channel within housing 120. In the state shown in FIG. 6C, CCPA 130 has been pushed further into the channel and is in a closed position. In this state, a tab 136 of CCPA 130 is aligned, in the direction in which the contact carrier is inserted or removed from housing 120, with tab 146. When CCPA is pushed into this second closed position after the contact carrier is inserted into housing 120 to its designed position, tab 136 interferes with tab 146, preventing the contact carrier from being moved out of position in the housing 120.

FIG. 6D is a perspective view of an illustrative contact carrier position assurance (CCPA) component.

FIG. 6E is a perspective view of the illustrative cable connector 200, showing a latch and CCPA.

As shown in FIGS. 6A-6E, the mating portion 610 of the contact carrier optionally comprises a tab 146 and a position assurance component 130 may be configured to latch at a closed position within a first opening 128 of the plug housing 120 and at which the position assurance component 130 engages the tab 146 of the contact carrier to hold the contact carrier within the chamber of the housing 120. As shown in FIGS. 6C and 6D, the position assurance component 130 may engage the contact carrier between the tab 146 and the cable mounting portion of the contact carrier. The first opening 128 may comprise a channel for entry of the position assurance component 130 and the position assurance component 130 may be configured to slide in the channel between an open position and a closed position. The position assurance component 130 may be configured to latch to the plug housing 120 at the open position and/or the closed position. The channel provided by first opening 128 of the plug housing 120 for entry of the position assurance component 130 may extend in a direction that is substantially perpendicular to a direction of another channel 670 of the plug housing 120 configured to accept the mating portion 610 of the contact carrier.

As shown in FIG. 6D, the position assurance component 130 may comprise a tab 136 that is configured to abut the tab 146 of the front shield 140 of the contact carrier when the position assurance component 130 is in a closed position. As further shown in FIG. 6D, the position assurance component 130 may comprise a base 652, a first arm 650A and a second arm 650B extending from the base 652 and configured to latch to the housing. In the examples illustrated in FIGS. 6C and 6D, the tab 136 of the position assurance component 130 is thinner than the first arm 650A and the second arm 650B of the position assurance component 130. Such a configuration may lead to a more compact connector. As further shown in FIG. 6D, the CCPA 130 has a first side and a second side, opposite the first side. The CCPA 130 may be inserted into insulative housing 120 with the first side facing the cable mounting portion 612 of the contact carrier such that the tab 136 of CCPA 130 is adjacent to the first side and offset from the second side. The tab 136 of CCPA 130 may be configured to engage with and hold the contact carrier within the chamber of the plug housing 120.

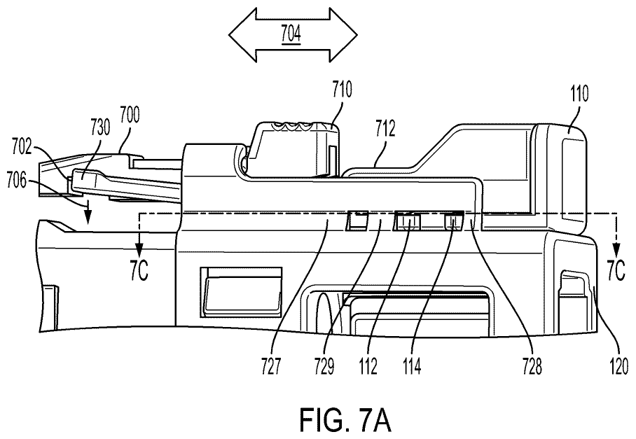

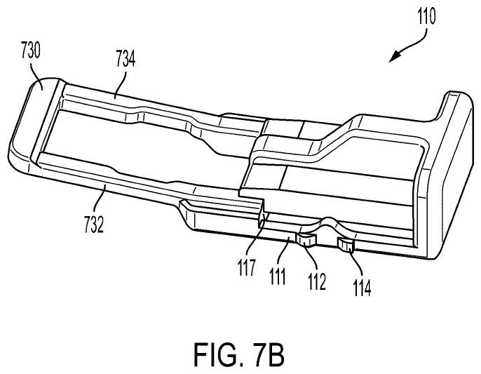

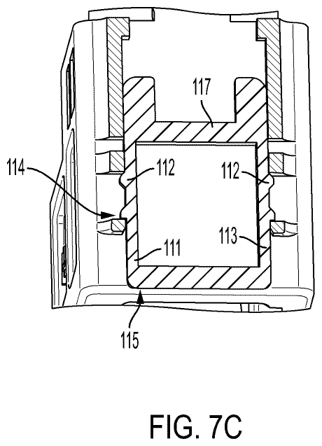

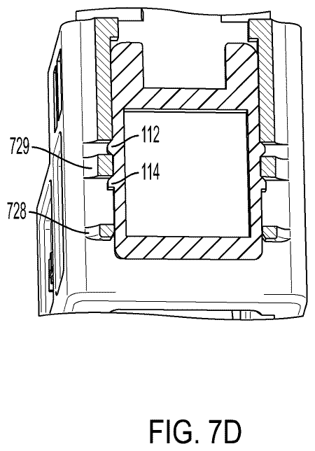

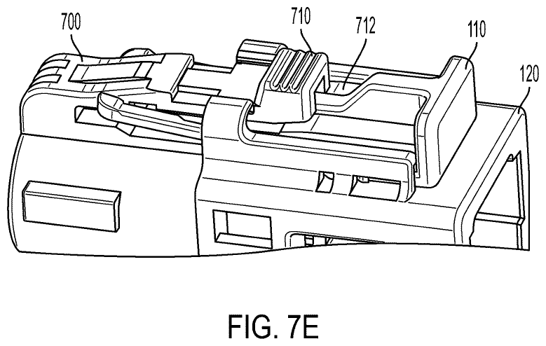

Optionally, as shown in FIGS. 7A and 7E, the insulative housing 120 may comprise a latch 700 configured to latch cable connector 200 to a mating connector, such as board connector 100 (FIG. 1). Cable connector 200 may include a connector position assurance component (CPA) 110 that is compact, yet ensures that connection between cable connector 200 and board connector is secure and reliable. CPA 110 may be configured to slide between an open and a closed state. CPA 110 may be configured such that, in the closed state, it blocks deflection of the latch 700 in a direction that would unlatch cable connector 200 from board connector 100. When CPA 110 is in the open position, it does not interfere with motion of latch 700, enabling latching or unlatching of latch 700.

FIG. 7A is an enlarged side view of a portion of a housing subassembly of the illustrative cable connector 200, showing latch 700 and CPA 110. In the illustrated state, CPA 110 is in an open position. An upper surface 712 of CPA 110 is offset from distal end 710 of latch 700. Accordingly, latch 700 is not blocked by CPA 110 from deflecting such that it can engage or disengage from a complementary latching feature in a mating connector.

In state illustrated in FIG. 7A, CPA 110 may be held in the open state by engagement of one or more features of CPA 110 to complementary engagement features on connector housing 120. For example, in the open state, member 730 fits within a notch 702 in housing 120. In this example, the walls of notch 702 are generally perpendicular to a direction 704 in which CPA 110 may slide within a channel of housing 120 between an unlocked and a locked state such that a relatively large force would be required to slide CPA 110 in direction 704 without first removing member 730 from notch 702. In this example, member 730 is at the distal ends of arms 732 and 734 that may flex when a force in a downward direction 706 is applied to them. Accordingly, these engagement features may be disengaged by a user pressing on member 730 in a direction 706.

FIG. 7A also indicates other engaging features which may be used instead of or addition to member 730 and notch 702. Alternatively or additionally, a projection 112 may be included. Projection 112 is on a complaint arm 111. In the open state illustrated in FIG. 7A, a forward surface of projection 112 abuts stop 729 of housing 120. The forward surface is cammed such that, if CPA 110 is pressed forwards with sufficient force, that cammed surface will generate a transverse force that deflects arm 111 until projection 112 clears stop 729. CPA 110 may then slide forward until member 730 abuts wall 703 (FIG. 6C) of housing 120. In this position, projection 112 may clear stop 729, enabling arm 111 to relax from its deflected state, with projection 112 on an opposite side of stop 729 (such as is shown in FIG. 7D). Projection 112 and stop 729 may be configured such that, when projection 112 is on the opposite side of stop 729, CPA 110 is in its closed position, such as in FIG. 7E where surfaces 712 of CPA 110 block motion of distal end 710 in a direction for latching or unlatching from a mating connector.

Arm 111 may have dimensions such that the force on CPA 110 in the sliding direction 704 required to generate a sufficient camming force at the interface between projection 112 and a side of stop 729 to deflect arm 111 is above a threshold, but not sufficiently low that the force could be generated by a human user intending to slide CPA 110 into a locked state while member 730 is being pressed to disengage from notch 702 (if these engagement features are present).

Alternatively or additionally, a projection 114 may be included on CPA 110. For example, projection 114 is shown abutting stop 728 when CPA 110 is in the open (i.e. unlocked) position illustrated in FIG. 7A. As can be seen in FIG. 7B, projection 114 may have a surface facing stop 728 that is perpendicular to the sliding direction 704. Unlike projection 112, such a surface generates little or no camming force in response to a force on CPA 110 urging projection 114 towards stop 728. In this example, projection 114 and stop 728 are positioned such that they contact when CPA 110 is in its open position. As little or no camming force is generated at that interface, little force is generated to move projection 114 in a direction in which it could clear stop 728. Accordingly, projection 114 and stop 728 interact to block CPA 110 for moving rearwards in the sliding direction 704 sufficient to be removed from housing 120. Rather, to remove CPA 110, a user might insert a tool into the opening between stops 728 and 729 to directly press on arm 111 to deflect it enough that projection 114 clears stop 728.

Optionally, a CPA as described herein may be operated with a bistable latching mechanism, tending to position the CPA in either an open (e.g. unlocked) position or a closed (e.g. locked) position. Such a bistable latching mechanism may urge CPA 110 out of a position that is neither open nor closed. Precluding the CPA being in such a position could reduce errors in operation that might otherwise occur from improperly securing a connector to amating connector. For example, as both sides of projection 112 are chamfered, force exerted by arm 111 to urge projection 112 towards stop 729 may generate a force that urges projection 112 to one side or the other of stop 729. As the positions on one side or the other correspond to the open and closed positions of the CPA, this force is generated when the CPA is between the open and closed positions and urges the CPA into either the open or closed position. Other features may preclude pressing the CPA further into the housing than the designed closed position and/or retracting the CPA out of the housing beyond the designed open position. For example, projection 114 interacting with stop 728 may restrict withdrawal of CPA 110 beyond the open position. Alternatively or additionally, projection 112 and wall 727 bounding the channel in which CPA 110 slides may cooperate to generate a camming force that urges CPA 110 back to the designed locked position if over-inserted.

Alternatively or additionally, the structures described above may be used to provide audible feedback to a user. As described above, if CPA 110 is between an open and closed position, the force generated by a camming surface of projection 112 interacting with stop 729 deflects arm 111. When CPA 110 slides into a closed or open position that force may cease and arm 111 may return to its undeflected state with sufficient force to generate a sound, such as a clock, which may serve as audible feedback to a user that the CPA is in a predetermined position, such as an open or a closed position.

FIG. 7B is a perspective view of the illustrative CPA 110 of FIG. 7A. FIG. 7B illustrates CPA 110 may be symmetrical such that the features discussed above in connection with FIG. 7A may be present on two sides of the connector housing. FIG. 7C is a sectional view of the illustrative cable connector housing subassembly of FIG. 7A, taken along line 7C-7C, with the illustrative CPA 110 in a first, unlocked position. in this view, a second arm 113, symmetrical with arm 111 is visible. FIG. 7D is a sectional view of the illustrative cable connector housing subassembly of FIG. 7A, taken along line 7C-7C, with the illustrative CPA 110 in a second, locked position. FIG. 7E is a top, perspective view of the illustrative cable connector housing subassembly of FIG. 7A with the CPA in the second, locked position.

As shown in FIGS. 7B and 7C, the connector position assurance device (CPA) 110 may comprise a first compliant arm 111 comprising a first protrusion 112 and a second protrusion 114 extending therefrom and may be disposed within a channel of the insulative housing 120. The CPA 110 may also comprise a second compliant arm 113, parallel to the first compliant arm 111 and also comprising first and second protrusions. The CPA 110 may also comprise a first cross member 115 connecting a first end of the first compliant arm 111 and the second compliant arm 113 and a second cross member 117 connecting a second end (opposite from the first end) of the first compliant arm 111 and the second compliant arm 113.

Optionally, as shown in FIGS. 7A, 7C, 7D and 7E, the insulative housing 120 may comprise a first stop 729 disposed within the channel and configured to engage the first protrusion 112 on the compliant arm 111 of the CPA 110. Motion of the CPA 110 in a second direction, opposite the first direction, may be blocked within the channel of the insulative housing 120 when the CPA 110 is in the locked position. Optionally, the insulative housing 120 may also comprise a second stop disposed within the channel and configured to engage the second protrusion 114 on the compliant arm 111 of the CPA 110 to block motion of the CPA within the channel in the first direction when the CPA is in an unlocked position at which the CPA is clear of the latch.

Having thus described several aspects of at least one embodiment of this invention, it is to be appreciated that various alterations, modifications, and improvements will readily occur to those skilled in the art.

For example, the contact carrier position assurance component 130 may include other types of latching features to engage a connector housing in an open and/or closed position.

As another example, techniques described herein may be used in connectors having configurations other than those described above.

Such alternative connector configurations may be used with all of the features described herein or a subset of any suitable number of features. Moreover, it should be appreciated that all of the structures, materials and construction techniques described herein may be used together, but, in some embodiments, some or all of the structures, materials or techniques may be omitted.

Such alterations or modifications are intended to be part of this disclosure and are intended to be within the spirit and scope of the invention. Further, though advantages of the present invention are indicated, it should be appreciated that not every embodiment of the invention will include every described advantage. Some embodiments may not implement any features described as advantageous herein and in some instances. Accordingly, the foregoing description and drawings are by way of example only.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

### EXAMPLES

In a first example, an electrical connector may comprise: a housing comprising a chamber and a first opening; a contact carrier comprising a mating portion extending in a first direction and a cable mounting portion extending in a second direction transverse to the first direction, wherein: the mating portion is positioned within the chamber of the housing and engaged to the housing; the mating portion comprises a tab; and a position assurance component configured to latch at a closed position within the first opening of the housing and at which the position assurance component engages the tab of the contact carrier to hold the contact carrier within the chamber of the housing such that the position assurance component engages the contact carrier between the tab and the cable mounting portion.

Optionally, the first opening comprises a channel extending in the second direction.

Optionally, the position assurance component is configured to slide in the channel between an open position and the closed position; and the position assurance component is configured to latch to the housing at the open position.

Optionally, the second direction is substantially perpendicular to the first direction.

Optionally, the position assurance component comprises a tab, and the tab of the position assurance component is configured to abut the tab of the contact carrier when the position assurance component is in the closed position.

Optionally, the position assurance component comprises: a base ; a first arm and a second arm extending from the base and configured to latch to the housing; the tab extending from the base.

Optionally, the tab of the position assurance component is thinner than the first arm and the second arm.

Optionally, the position assurance component has a first side and a second side, opposite the first side; the position assurance component is positioned with the first side facing the cable mounting portion; and the tab is adjacent the first side and offset from the second side.

Optionally, the contact carrier comprises a shield, the shield comprising the tab ; and the position assurance component comprises a tab configured to engage with the tab to hold the contact carrier within the chamber of the housing.

Optionally, the contact carrier comprises at least one electrical contact ; the electrical connector is in combination with a cable, the cable comprising a jacket surrounding at least one electrical conductor and a shielding layer between the jacket and the at least one electrical conductor.

Optionally, the electrical connector further comprises: a die cast member comprising a tail ; wherein the die cast member is attached to the cable with the tail presses against an exposed portion of the shielding layer.

Optionally, the contact carrier comprises an inner housing comprising a slot ; and the electrical contact comprises a dimple; and the dimple is disposed in the slot.

Optionally, the contact carrier further comprises a terminal position assurance component positioned to block withdrawal of the dimple from the slot.

Optionally, the electrical connector further comprises: a second position assurance component comprising a first protrusion wherein the housing further comprises a shelf having a first side and a second side, the first protrusion positioned against the first side of the shelf of the second position assurance component to secure the second position assurance component in the housing.

Optionally, the second position assurance component comprises a second protrusion , the second protrusion positioned against the second side of the shelf of the second position assurance component to further secure the second position assurance component in the housing.

In a second example, an electrical connector may comprise: a housing comprising a chamber, a first opening and a latch; and a contact carrier comprising a mating portion extending in a first direction and a cable mounting portion extending in a second direction transverse to the first direction, wherein: the mating portion is within the chamber of the housing, the contact carrier comprises a projection; and the latch engages the projection to latch the contact carrier within the chamber of the housing; and a position assurance component positioned within the first opening of the housing and configured to slide into a closed position at which the position assurance component blocks withdrawal of the contact carrier from the chamber of the housing.

Optionally, the housing comprises an insulative housing and the latch comprises an arm integrally molded with the insulative housing.

Optionally, the electrical connector further comprises: a conductive housing; wherein the contact carrier comprises an insulative housing comprising a channel and a contact disposed within the channel; and the conductive housing comprises the projection of the contact carrier.

Optionally, the conductive housing is a die cast member; and the conductive housing comprises an integrally formed portion of the die cast member.

Optionally, the first opening comprises a channel extending in the second direction.

Optionally, the position assurance component is configured to slide in the channel between an open position and the closed position; and the position assurance component is configured to latch to the housing at the open position.

Optionally, the second direction is substantially perpendicular to the first direction.

Optionally, the position assurance component comprises a tab, and the tab of the position assurance component is configured to abut the tab of the contact carrier when the position assurance component is in the closed position.

Optionally, the position assurance component comprises: a base ; a first arm and a second arm extending from the base and configured to latch to the housing; the tab extends from the base.

Optionally, the tab of the position assurance component is thinner than the first arm and the second arm.

Optionally, the position assurance component has a first side and a second side, opposite the first side; the position assurance component is positioned with the first side facing the cable mounting portion; and the tab is adjacent the first side and offset from the second side.

Optionally, the contact carrier comprises a shield, the shield comprising the tab; and the position assurance component comprises a tab configured to engage with the tab to hold the contact carrier within the chamber of the housing.

Optionally, the contact carrier comprises at least one electrical contact; the electrical connector is in combination with a cable, the cable comprising a jacket surrounding the at least one electrical contact, the jacket having an oval cross-section.

Optionally, the electrical connector further comprises: a die cast member comprising at least one step positioned within the chamber of the housing; and a shield; wherein the cable comprises a braid and the step ensures that the die cast member presses against the braid.

Optionally, the contact carrier comprises an inner housing comprising a slot; and the electrical contact comprises a dimple; and the dimple is disposed in the slot.

Optionally, the contact carrier further comprises a terminal position assurance component positioned to block withdrawal of the dimple from the slot.

Optionally, the electrical connector further comprises: a second position assurance component comprising a first protrusion wherein the housing further comprises a shelf having a first side and a second side, the first protrusion positioned against the first side of the shelf of the second position assurance component to secure the second position assurance component in the housing.

Optionally, the second position assurance component comprising a second protrusion, the second protrusion positioned against the second side of the shelf of the second position assurance component to further secure the second position assurance component in the housing.

In a third example, a cable assembly may comprise: a cable comprising a conductor; an electrical connector, comprising: an outer housing comprising a chamber; a conductive housing comprising a portion comprising a chamber at least partially positioned within the chamber of the outer housing; an insulative housing comprising a channel disposed within the chamber of the conductive housing; a contact comprising a mating portion disposed within the channel of the insulative housing and a tail attached to the conductor of the cable, wherein the conductive housing further comprises a tail configured to support the cable.

Optionally, the cable assembly further comprises: an integral sheet comprising a first portion at least partially encircling the tail and the cable.

Optionally, the integral sheet comprises an outer ferrule; the electrical connector further comprises an inner ferrule disposed over the cable; and the first portion of the integral sheet at least partially encircles the tail, the cable and the inner ferrule.

Optionally, the cable comprises a jacket and a shield; the cable shield extends beyond the jacket and is disposed between the inner ferrule and the outer ferrule.

Optionally, the tail comprises a stepped portion extending toward the cable; an end of the cable shield is between and in contact with the stepped portion and the cable jacket.

Optionally, the inner ferrule comprising a first portion with a circular cross-section and a second portion comprising an oval cross-section; and the first portion of the integral sheet at least partially encircles the tail, the cable and the first portion of the inner ferrule such that the shield is between and in contact with the inner ferrule and the outer ferrule over substantially all of a circumference of the first portion of the inner ferrule.

Optionally, the integral sheet comprises a second portion; the second portion at least partially encircles the cable at a location offset from the tail.

Optionally, the chamber of the conductive housing comprises an entrance; the integral sheet comprises a third portion covering the entrance.

Optionally, the conductive housing comprises at least one embossment holding the third portion to the conductive housing.

Optionally, the third portion comprises a planar portion and an embossed region offset from the planar portion.

Optionally, the mating portion of the contact is elongated in a first direction and the tail extends in a second direction, perpendicular to the first direction; the conductor of the cable comprises a distal portion extending in the second direction within the conductive housing; and the distal portion of the conductor is adjacent to the embossed region of the third portion.

Optionally, the embossed region extends into the chamber of the conductive housing; and the inner ferrule is outside the chamber of the conductive housing.

In a fourth example, a housing subassembly for an electrical connector may comprise: an insulative housing comprising a latch and a channel; and a connector position assurance device (CPA) disposed within the channel, wherein: the CPA comprises: a compliant arm comprising a protrusion extending therefrom, the protrusion comprising a camming surface; and a distal portion; the insulative housing further comprises a stop disposed within the channel and configured to engage the camming surface of the protrusion to urge the protrusion into a predetermined position; and the housing subassembly is configured such that a portion of the insulative housing blocks motion of the CPA within the channel beyond the predetermined position.

Optionally, the compliant arm is a first compliant arm; and the CPA further comprises a second compliant arm, parallel to the first compliant arm.

Optionally, the CPA further comprises a first cross member connecting a first end of the first compliant arm and the second compliant arm and a second cross member connecting a second end, opposite the first end of the first compliant arm and the second compliant arm.

Optionally, the stop is a first stop and the protrusion is a first projection; the CPA comprises a second projection on the compliant arm; and the insulative housing comprises a second stop disposed within the channel and configured to engage the second projection to block motion of the CPA within the channel in the first direction when the CPA is in an unlocked position at which the CPA is clear of the latch.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. An electrical connector (100), comprising:
a housing (120) comprising a chamber and a first opening (128);
a contact carrier comprising a mating portion extending in a first direction and a cable mounting portion extending in a second direction transverse to the first direction, wherein:
the mating portion is positioned within the chamber of the housing and engaged to the housing;
the mating portion comprises a tab (146); and
a position assurance component (130) configured to latch at a closed position within the first opening of the housing and at which the position assurance component engages the tab (146) of the contact carrier to hold the contact carrier within the chamber of the housing such that the position assurance component engages the contact carrier between the tab (146) and the cable mounting portion.

2. The electrical connector of claim 1 wherein the first opening comprises a channel extending in the second direction.

3. The electrical connector of claim 2, wherein:
the position assurance component is configured to slide in the channel between an open position and the closed position; and
the position assurance component (130) is configured to latch to the housing at the open position.

4. The electrical connector of claim 1 wherein the second direction is substantially perpendicular to the first direction.

5. The electrical connector of claim 1 wherein the position assurance component (130) comprises a tab (136), and the tab of the position assurance component is configured to abut the tab (146) of the contact carrier when the position assurance component is in the closed position.

6. The electrical connector of claim 5, wherein:
the position assurance component comprises:
a base (652)
a first arm (650A) and a second arm (650B) extending from the base and configured to latch to the housing;
the tab (136) extends from the base.

7. The electrical connector of claim 6, wherein:
the tab (136) of the position assurance component is thinner than the first arm and the second arm.

8. The electrical connector of claim 7, wherein:
the position assurance component has a first side and a second side, opposite the first side;
the position assurance component is positioned with the first side facing the cable mounting portion; and
the tab is adjacent the first side and offset from the second side.

9. The electrical connector of claim 1, wherein:
the contact carrier comprises a shield, the shield (140) comprising the tab (146); and
the position assurance component comprises a tab (136) configured to engage with the tab to hold the contact carrier within the chamber of the housing.

10. The electrical connector of claim 3 wherein:
the contact carrier comprises at least one electrical contact (180);
the electrical connector is in combination with a cable (300), the cable comprising a jacket (302) surrounding at least one electrical conductor and a shielding layer between the jacket and the at least one electrical conductor.

11. The electrical connector of claim 10 further comprising:
a die cast member comprising a tail (152); and
wherein the die cast member is attached to the cable with the tail presses against an exposed portion of the shielding layer.

12. The electrical connector of claim 10 wherein:
the contact carrier comprises an inner housing (160) comprising a slot (162); and
the electrical contact (180) comprises a dimple (182); and
the dimple is disposed in the slot.

13. The electrical connector of claim 12 wherein the contact carrier further comprises a terminal position assurance component positioned to block withdrawal of the dimple from the slot.

14. The electrical connector of claim 1 further comprising:
a second position assurance component (110) comprising a first protrusion (112) wherein the housing further comprises a shelf (729) having a first side and a second side, the first protrusion positioned against the first side of the shelf of the second position assurance component to secure the second position assurance component in the housing.

15. The electrical connector of claim 14 wherein:
the second position assurance component (110) comprising a second protrusion (114), the second protrusion positioned against the second side of the shelf of the second position assurance component to further secure the second position assurance component in the housing.

16. An electrical connector comprising:
a housing (120) comprising a chamber, a first opening (128) and a latch (122); and
a contact carrier comprising a mating portion extending in a first direction and a cable mounting portion extending in a second direction transverse to the first direction, wherein:
the mating portion is within the chamber of the housing,
the contact carrier comprises a projection (144); and
the latch (122) engages the projection to latch the contact carrier within the chamber of the housing; and
a position assurance component (130) positioned within the first opening of the housing and configured to slide into a closed position at which the position assurance component blocks withdrawal of the contact carrier from the chamber of the housing.

17. The electrical connector of claim 16, wherein:
the housing comprises an insulative housing (160) and the latch comprises an arm integrally molded with the insulative housing.

18. The electrical connector of claim 17, further comprising:
a conductive housing (150);
wherein the contact carrier comprises an insulative housing comprising a channel and a contact disposed within the channel; and
the conductive housing comprises the projection of the contact carrier.

19. The electrical connector of claim 18, wherein:
the conductive housing is a die cast member; and
the conductive housing comprises an integrally formed portion of the die cast member.

20. The electrical connector of claim 16 wherein the first opening comprises a channel extending in the second direction.

21. The electrical connector of claim 20, wherein:
the position assurance component is configured to slide in the channel between an open position and the closed position; and
the position assurance component (130) is configured to latch to the housing at the open position.

22. The electrical connector of claim 16 wherein the second direction is substantially perpendicular to the first direction.

23. The electrical connector of claim 16 wherein the position assurance component (130) comprises a tab (136), and the tab of the position assurance component is configured to abut the tab (146) of the contact carrier when the position assurance component is in the closed position.

24. The electrical connector of claim 23, wherein:
the position assurance component comprises:
a base (652)
a first arm (650A) and a second arm (650B) extending from the base and configured to latch to the housing;
the tab (136) extends from the base.

25. The electrical connector of claim 24, wherein:
the tab (136) of the position assurance component is thinner than the first arm and the second arm.

26. The electrical connector of claim 25, wherein:
the position assurance component has a first side and a second side, opposite the first side;
the position assurance component is positioned with the first side facing the cable mounting portion; and
the tab is adjacent the first side and offset from the second side.

27. The electrical connector of claim 16, wherein:
the contact carrier comprises a shield, the shield (140) comprising the tab (146); and
the position assurance component comprises a tab (136) configured to engage with the tab to hold the contact carrier within the chamber of the housing.

28. The electrical connector of claim 27, wherein:
the contact carrier comprises at least one electrical contact (180);
the electrical connector is in combination with a cable (300), the cable comprising a jacket (.) surrounding the at least one electrical contact, the jacket having an oval cross-section.

29. The electrical connector of claim 28 further comprising:
a die cast member comprising at least one step (153) positioned within the chamber of the housing; and
a shield;
wherein the cable comprises a braid and the step ensures that the die cast member presses against the braid

30. The electrical connector of claim 29 wherein:
the contact carrier comprises an inner housing (160) comprising a slot (162); and
the electrical contact (180) comprises a dimple (182); and
the dimple is disposed in the slot.

31. The electrical connector of claim 30 wherein the contact carrier further comprises a terminal position assurance component positioned to block withdrawal of the dimple from the slot.

32. The electrical connector of claim 16 further comprising:
a second position assurance component (110) comprising a first protrusion (112) wherein the housing further comprises a shelf (729) having a first side and a second side, the first protrusion positioned against the first side of the shelf of the second position assurance component to secure the second position assurance component in the housing.

33. The electrical connector of claim 32 wherein:
the second position assurance component (110) comprising a second protrusion (114), the second protrusion positioned against the second side of the shelf of the second position assurance component to further secure the second position assurance component in the housing.

34. A cable assembly, comprising:
a cable comprising a conductor;
an electrical connector (100), comprising:
an outer housing (120) comprising a chamber;
a conductive housing (150) comprising a portion comprising a chamber (510) at least partially positioned within the chamber of the outer housing;
an insulative housing comprising a channel disposed within the chamber of the conductive housing;
a contact comprising a mating portion disposed within the channel of the insulative housing and a tail attached to the conductor of the cable,
wherein the conductive housing further comprises a tail (152) configured to support the cable.

35. The cable assembly of claim 34, further comprising:
an integral sheet comprising a first portion at least partially encircling the tail and the cable.

36. The cable assembly of claim 35, wherein:
the integral sheet comprises an outer ferrule;
the electrical connector further comprises an inner ferrule disposed over the cable; and
the first portion of the integral sheet at least partially encircles the tail, the cable and the inner ferrule.

37. The cable assembly of claim 36, wherein:
the cable comprises a jacket and a shield;
the cable shield extends beyond the jacket and is disposed between the inner ferrule and the outer ferrule.

38. The cable assembly of claim 37, wherein:
the tail comprises a stepped portion extending toward the cable;
an end of the cable shield is between and in contact with the stepped portion and the cable jacket.

39. The cable assembly of claim 37, wherein:
the inner ferrule comprising a first portion with a circular cross-section and a second portion comprising an oval cross-section; and
the first portion of the integral sheet at least partially encircles the tail, the cable and the first portion of the inner ferrule such that the shield is between and in contact with the inner ferrule and the outer ferrule over substantially all of a circumference of the first portion of the inner ferrule.

40. The cable assembly of claim 35, wherein:
the integral sheet comprises a second portion;
the second portion at least partially encircles the cable at a location offset from the tail.

41. The cable assembly of claim 40, wherein:
the chamber of the conductive housing comprises an entrance;
the integral sheet comprises a third portion covering the entrance.

42. The cable assembly of claim 41, wherein:
conductive housing comprises at least one embossment holding the third portion to the conductive housing.

43. The cable assembly of claim 41, wherein:
the third portion comprises a planar portion and an embossed region offset from the planar portion.

44. The cable assembly of claim 43, wherein:
the mating portion of the contact is elongated in a first direction and the tail extends in a second direction, perpendicular to the first direction;
the conductor of the cable comprises a distal portion extending in the second direction within the conductive housing; and
the distal portion of the conductor is adjacent to the embossed region of the third portion.

45. The cable assembly as in claim 44, wherein:
embossed region extends into the chamber of the conductive housing; and
the inner ferrule is outside the chamber of the conductive housing.

46. A housing subassembly for an electrical connector, comprising:
an insulative housing (120) comprising a latch and a channel; and
a connector position assurance device (CPA) (110) disposed within the channel, wherein:
the CPA comprises:
a compliant arm comprising a protrusion (112) extending therefrom, the protrusion comprising a camming surface; and
a distal portion;
the insulative housing further comprises a stop (729) disposed within the channel and configured to engage the camming surface of the protrusion to urge the protrusion into a predetermined position; and
the housing subassembly is configured such that a portion of the insulative housing blocks motion of the CPA within the channel beyond the predetermined position.

47. The housing subassembly of claim 46 wherein:
the compliant arm is a first compliant arm; and
the CPA further comprises a second compliant arm, parallel to the first compliant arm.

48. The housing subassembly of claim 47 wherein the CPA further comprises a first cross member connecting a first end of the first compliant arm and the second compliant arm and a second cross member connecting a second end, opposite the first end of the first compliant arm and the second compliant arm.

49. The housing subassembly of claim 46, wherein:
the stop is a first stop and the projection is a first projection;
the CPA comprises a second projection on the compliant arm; and
the insulative housing comprises a second stop disposed within the channel and configured to engage the second protrusion to block motion of the CPA within the channel in the first direction when the CPA is in an unlocked position at which the CPA is clear of the latch.
